(19) United States
(12) Patent Application Publication
(10) Pub. No.: US 2010/0206527 A1
(43) Pub. Date: Aug. 19, 2010

(54) In-Situ Treatment of Metallic Surfaces

(76) Inventors: Lin-wen Hu, Lexington, MA (US); Jacopo Buongiorno, Burlington, MA (US); Bao H. Truong, Quincy, MA (US); Heather M. Feldman, Charlotte, NC (US)

Correspondence Address: CURATOLO SIDOTI CO., LPA, 24500 CENTER RIDGE ROAD, SUITE 280, CLEVELAND, OH, 44145, US

(21) Appl. No.: 12/700,883

(22) Filed: Feb. 5, 2010

Related U.S. Application Data
(60) Provisional application No. 61/153,441, filed on Feb. 18, 2009.

(51) Int. Cl. F28F 13/18; B05D 3/00; B05D 3/02

(52) U.S. Cl. 165/133; 427/189; 427/191; 427/560; 427/192; 427/190

(57) ABSTRACT

A method for in-situ treatment of a metallic surface utilizing a nanoparticle dispersion to increase at least one of (i) the critical heat flux. (ii) the boiling heat transfer rate, or (iii) the corrosion resistance of the metallic surface when in operation without a nanofluid heat transfer liquid, comprising: (1) cleaning the metallic surface: (2) conditioning the metallic surface to enhance nanoparticle binding to the metallic surface by applying a polymeric binding agent; (3) forming at least one thin film layer of nanoparticles on the metallic surface by contacting the nanoparticle dispersion with the metallic surface at a temperature and pressure sufficient to boil the nanoparticle dispersion; and, optionally (4) curing the nanoparticle layer by heating the metallic surface to a temperature higher than the temperature sufficient to boil the nanoparticle dispersion.

### CROSS REFERENCE TO RELATED APPLICATIONS

This application claims the benefit of U.S. Provisional Patent Application Ser. No. 61/153,441 filed Feb. 18, 2009 pursuant to 35 U.S.C. §119(e), which application is incorporated herein by reference.

### BACKGROUND

A method is provided for in-situ treatment of metallic surfaces in order to provide improvements in at least one of the critical heat flux, the boiling heat transfer rate, or the corrosion resistance of the metallic surface by depositing a nanoparticle thin film on the metallic surface.

Many important industrial applications rely on nucleate boiling to remove high heat fluxes from a heated surface. These include, but are not limited to, cooling of nuclear reactors, chemical reactors, and refrigeration systems, which are processes which include the use of shell-and-tube heat exchangers, boilers and steam generators.

Nucleate boiling is a very effective heat transfer mechanism, however, it is well known that there exists a critical value of the heat flux at which nucleate boiling transitions to film boiling, a very poor heat transfer mechanism. In most practical applications, it is desired to maintain the operating heat flux below such critical value, which is called the critical heat flux (“CHF”). Thus, a high CHF value is desirable, because the allowable power density that can be handled by a cooling system based on nucleate boiling is approximately proportional to the CHF. Therefore, an increase in the CHF can result in more compact and efficient cooling systems, with significant economic and/or safety benefits in all applications of nucleate boiling.

For example, a Pressurized Water Reactor (PWR), a common type of nuclear power generating reactor, typically utilizes ordinary water as both coolant and moderator. The design is distinguished by having a primary cooling circuit which flows through the core of the reactor under very high pressure, and a secondary circuit in which steam is generated to drive the turbine. The secondary circuit is under less pressure than the primary circuit and the water in the secondary circuit boils in steam generators which transfer heat due to nucleate boiling. Therefore, an increase in the CHF in the secondary circuit could result in a much safer system by providing a broader range of safe operation, or the heat transfer could be increased in order to generate a larger amount of steam.

Rough or porous metallic surfaces transfer heat much more efficiently than smooth metallic surfaces due to the ability of rough or porous surfaces to increase the CHF of the system. A rough or porous surface tends to have higher nucleation site density, resulting in an increase of the boiling heat transfer rate.

The reason for the increase in the CHF due to rough or porous surfaces is complex. With regard to rough or porous surfaces created through particle deposition, the important parameters are known to include particle size, range of pore sizes, surface tension of the heat transfer liquid, and the surface wettability.

U.S. Pat. No. 3,587,730 to Robert M. Milton describes a porous metallic surface which provides many times the heat transfer efficiency (and thus a higher CHF) of smooth metallic surfaces during boiling heat transfer, therefore allowing the temperature difference between the metallic surface and the heat transfer fluid to be reduced, the heat transfer area to be reduced, the total heat transfer to increase, or any combination of these improvements. Unfortunately, the process for creating the porous surface disclosed by Milton is quite arduous, requiring sintering, soldering, brazing, or otherwise thermally bonding a layer of fine particles to the metallic surface.

Others have developed various methods which allow for the production of rough or porous metallic surfaces, including various methods of particle deposition onto the metallic surface. However, all of these methods are costly and difficult to perform, and usually cannot be performed in-situ, or while the heat transfer apparatus remains a functional part of the system which it supports.

Many heat transfer apparatus comprise large systems which are a part of even larger chemical processes, such as power plants, chemical manufacturing plants, etc. The heat transfer surfaces of these large heat transfer apparatus are conditioned prior to installation in order to provide increased heat transfer efficiency, corrosion resistance, and other important properties. Over time, the conditioning of these surfaces wears away and the surfaces become susceptible to corrosion and decreases in heat transfer efficiency. Once assembled, however, it is very difficult to recondition the heat transfer surfaces because many of the known reconditioning methods require in-shop treatment of the surfaces, which requires disassembly of the apparatus, transferring the components to a treatment facility, treatment, transferring back to the originating facility, and reassembling the apparatus, resulting in long periods of down time. Such in-shop treatment methods are impractical (and perhaps impossible) for large-scale heat transfer components due to the extreme cost and difficulty associated with reconditioning and the downtime experienced due to disassembly.

Traditionally, these large-scale heat transfer apparatus are flushed with chemicals periodically to remove surface fouling. However, the surface properties, such as the surface chemical composition and surface roughness, cannot be restored to optimize the heat transfer or corrosion resistant characteristics of the initial shop-applied treatment. Furthermore, chemical treatment alone may result in thinning of heat exchanger tubes and/or plates and subsequent leaks. If not treated, fouling, corrosion, and the buildup of an oxidation layer will result in a loss of heat transfer performance.

### BRIEF DESCRIPTION OF THE DRAWINGS

FIG. 1 is a schematic diagram of an apparatus for determining heat transfer coefficients and critical heat flux.

FIG. 2 is a graphical representation of heat flux versus heat transfer coefficient.

### DETAILED DESCRIPTION

A method is provided for in-situ treatment of a metallic surface utilizing a nanoparticle dispersion in order to increase at least one of (i) the critical heat flux, (ii) the boiling heat transfer rate, or (iii) the corrosion resistance of the metallic surface when in operation without a nanofluid heat transfer liquid, that is, when the operational heat transfer liquid is not a nanoparticle dispersion.

In one embodiment, a method is provided for in-situ treatment of a metallic surface utilizing a nanoparticle dispersion in order to increase at least one of (i) the critical heat flux, (ii) the boiling heat transfer rate, or (iii) the corrosion resistance of the metallic surface when in operation without a nanofluid heat transfer liquid, comprising: (1) cleaning the metallic surface; (2) conditioning the metallic surface to enhance nanoparticle binding to the metallic surface by applying a polymeric binding agent, such as in a liquid dispersion; (3) forming at least one thin film layer of nanoparticles on the metallic surface by contacting the nanoparticle dispersion with the metallic surface at a temperature and pressure sufficient to boil the nanoparticle dispersion; and, (4) optionally curing the nanoparticle layer by heating the metallic surface to a temperature higher than the temperature sufficient to boil the nanoparticle dispersion.

As used herein, the term “in-situ treatment” means treatment of an apparatus while it remains functionally or physically in communication with the larger system of which the apparatus is a part.

As used herein, the term “nanoparticle” means any particle having a particle size of less than or equal to about 1 μm.

As used herein, the term “nanoparticle dispersion” means a dispersion or colloidal suspension of nanoparticles in any suitable solvent.

As used herein, the term “surface wettability” is a surface property which is measured by the angle of contact between the liquid and the particle surface, and is thus dependent upon both the type of fluid and the other surface properties.

Various high concentration nanoparticle dispersions are commercially available. For purposes of the present method, nanoparticle dispersions may be prepared by any method known in the art, and may utilize any suitable nanoparticle materials. One such nanoparticle dispersion preparation method includes purchasing a commercially available high concentration nanoparticle dispersion and diluting it to the desired concentration with a suitable solvent.

In one embodiment of the treatment method, the nanoparticle dispersion comprises a dispersion of a liquid solvent and/or dispersive agent and at least one of (i) metal nanoparticles, (ii) metal-oxide nanoparticles, (iii) carbon-based nanoparticles, (iv) nanoparticles of at least one of types (i), (ii), or (iii) stabilized by surfactants, or (v) nanoparticles of at least one of types (i), (ii), (iii) or (iv) with at least one polymeric binding agent as described below. The surfactants are commercially available and present in commercial nanoparticle dispersions. Nanoparticle dispersions of types (i) through (iv) are known in the art, and many are commercially available.

In certain embodiments, the nanoparticle dispersion comprises from about 0.01% to about 5% by volume of nanoparticles. The average particle size of the nanoparticles may range from about 1 nm to about 1,000 nm. Suitable nanoparticles may include, but are not limited to, at least one of alumina, titania, silica, zinc oxide, iron oxide, ceria, zirconia, gold, silver, or copper. In some embodiments, the carbon-based nanoparticles, if present, comprise at least one of carbon nanotubes, diamond, graphite, or fullerenes. The liquid solvent may be water, an organic-based solvent, or an inorganic-based solvent. In some embodiments, the liquid solvent may be at least one of fluorocarbons, ethylene glycol, or polyalphaolefins and the like.

It has been shown that nanoparticle dispersions, when used as the heat transfer liquid in a nucleate boiling heat transfer apparatus, have a profound effect in increasing the CHF, and therefore the boiling heat transfer of the system. In pool boiling experiments, a CHF increase of 200% has been shown when comparing use of a nanoparticle dispersion versus pure water. Similar flow boiling experiments have shown a CHF increase of up to 50% when comparing use of a nanoparticle dispersion versus pure water. The increase in CHF when using nanoparticle dispersions as the heat transfer fluid may be caused by nanoparticle deposition on the heat transfer surface. While not wishing to be limited by theory, it is believed that nanoparticle deposition occurs when the solvent vaporizes upon contact with the heated surface, permitting any nanoparticles dispersed in that solvent to attach to the heated surface.

Many of the suitable nanoparticles utilized in the present method are not susceptible to corrosion, and, upon deposition on the heated surface, will protect the heated surface from corrosion caused by the heat transfer liquid. Those skilled in the art will be able to select a suitable nanoparticle type in order to provide an increase in corrosion protection to the heat transfer surface to be treated.

Many of the experiments performed to date have utilized a nanoparticle dispersion as the heat transfer liquid. This is necessary because the nanoparticle depositions created when the boiling nanoparticle dispersion comes into contact with the heated surface are fragile and susceptible to erosion. Therefore, they will not remain deposited on the heated surface for any acceptable length of time, and the constant presence of the nanoparticle dispersion has been necessary to maintain an acceptable nanoparticle deposition on the heated surface and to maintain increased CHF.

It has now been discovered that, by utilizing the present method, the nanoparticle deposition can be effectively affixed to the heated surface to provide acceptable durability to achieve an increase in CHF using conventional heat transfer liquids rather than nanoparticle dispersions. Since the direct use of nanoparticle dispersions as heat transfer liquids is not feasible in many heat transfer systems, the present method provides a pre-treatment process for the heated surface which allows for use of conventional heat transfer liquids while providing the exceptional increase in CHF due to the nanoparticle deposition on the heated surface. Suitable heat transfer liquids include, but are not limited to, water, refrigerants, ethanol, and ethylene glycol.

The present method comprises: (1) cleaning the metallic surface, such as, but not limited to, at least one of chemically flushing, sludge lancing, or ultrasonically cleaning the metallic surface to remove corrosion products and other deposits: (2) conditioning the metallic surface to enhance nanoparticle binding to the metallic surface by applying a polymeric binding agent; (3) forming at least one thin film layer of nanoparticles on the metallic surface by contacting the nanoparticle dispersion with the metallic surface at a temperature and pressure sufficient to boil the nanoparticle dispersion; and, (4) optionally curing the nanoparticle layer by heating the metallic surface to a temperature higher than the temperature sufficient to boil the nanoparticle dispersion.

Procedures for cleaning the metallic surface are known. Among them are chemical flushing, sludge lance, and ultrasonically cleaning the metallic surface. A suitable cleaning procedure can be determined by a person of skill in the art to be followed according to the present method. One embodiment of the present method includes utilizing a stream of liquid to remove any residuals after chemical flushing, sludge lancing, or ultrasonically cleaning the metallic surface.

Chemical solutions can be removed from the system via a shunt or valve and treated with ion-exchange resins, ion-exchange resin columns, and/or mixed-bed resin columns as appropriate.

Cleaning procedures useful for the secondary side, such as for steam generators, in pressurized water reactors that may be utilized according to the present method include the Electric Power Research Institute Steam Generator Owners Group process (EPRI SGOG), the Electricite de France process (EdF), the Siemens Kraftwerk Union (KWU) process, and processes which utilize Advanced Scale Conditioning Agents (ASCAs). Each of these processes can be tailored by one of skill in the art to meet the cleaning needs of a particular steam generator or other metallic heat transfer surface. Other known methods of in-situ cleaning of metallic heat transfer surfaces may be used in addition or in the alternative.

The EPRI SGOG process includes three solvent steps, which are referred to as the iron solvent, the copper solvent, and the crevice solvent steps. The process is applied with the appropriate rinse sequences and generally ends with a passivation step. All three of the solvents may utilize the diammonium salt of EDTA.

The iron solvent in one embodiment may include 10% by weight EDTA and 1% by weight hydrazine, have a pH of 7, which may be adjusted using NH₄OH, and further includes from 0.5 to 1.0% by volume of petrolite inhibitor. The iron solvent may be applied at temperatures ranging from 88° C. to 96° C. (190° F. to 205° F.).

The copper solvent in one embodiment may include 5% by weight EDTA and from 2 to 3% by weight hydrogen peroxide. It may have a pH of 9.5, initially adjusted to 7 with NH₄OH, then brought up to 9.5 with ethylenediamine (EDA). The copper solvent may be applied at temperatures ranging from 32° C. to 43° C. (90° F. to 110° F.).

The crevice solvent in one embodiment may include 20% by weight EDTA and 1.0% by volume petrolite inhibitor. It may have a pH of 6, adjusted with NH₄OH. The crevice solvent may be applied at temperatures ranging from 118° C. to 124° C. (245° F. to 255° F.).

The passivation step in one embodiment may utilize a 0.03% solution of hydrazine with a pH of 10, adjusted using NH₄OH. The passivation step may be performed at temperatures ranging from 91° C. to 96° C. (195° F. to 205° F.).

An example of one embodiment of the EPRI SGOG process, run without a crevice solvent step, includes the following: (1) performing an initial checkout rinse for 26 hours while simultaneously heating the steam generator system to 93° C. (200° F.); (2) applying the iron solvent at 93° C. (200° F.) for 40 hours; (3) rinsing the system for 18 hours while simultaneously cooling the system to 38° C. (100° F.); (4) applying the copper solvent at 38° C. (100° F.) for 7 hours; (5) rinsing the system for 10 hours while heating the system to 60° C. (140° F.); (6) performing a final rinse for 18 hours while simultaneously heating the system to 93° C. (200° F.); and (7) performing the passivation step at 93° C. (200° F.) for 17 hours.

The EPRI SGOG process corrosion and process monitoring may be conducted using both corrosion coupons and electrochemical on-line monitors. Coupons of selected materials used in the construction of the steam generator being cleaned are prepared and preweighed. These coupons are then placed in a side steam monitor vessel or inside the steam generator. The placement of the coupons may be in a geometry to replicate conditions in the steam generator with respect to generator material and dissolving deposit locations. After cleaning, the coupons provide documentation of the corrosion due to cleaning.

Electrochemical monitors, linear polarization (LP), zero resistance ammetry (ZRA) and electrochemical noise can also be used. These monitors may have their sensing probes placed in the same location as the corrosion coupons. A comprehensive corrosion monitoring program will include as a minimum linear polarization and zero resistance ammetry measurements to provide multiple signals and cover both free and galvanic corrosion. Electrochemical monitor data will not give absolute corrosion readings. It will, however, give warnings of “off normal cleaning conditions” and track accumulated corrosion.

The EdF process is designed to dissolve iron oxide and copper with a single solution. The iron removal phase utilizes a combination of gluconic acid and citric acid with an inhibitor, P6 from Multiserve, and ammonia, which is added as necessary to obtain a pH of 3.3 at 24° C. (75° F.). The treatment temperature is 85° C. (185° F.) and during this phase a nitrogen blanket may be used to exclude oxygen. The copper removal phase may utilize the same solution, except that it may be made alkaline with ammonia at a pH of 10 and oxidation is obtained by air bubbling. A final phase is performed to eliminate traces of inhibitor and to passivate the steam generator surfaces.

The KWU process includes a high temperature iron removal process and a low temperature copper removal process. For crevice cleaning, one additional iron removal step is applied, normally at the higher end of the approved temperature range. The process is designed to make maximum use of installed plant systems and equipment. Portable equipment required includes a chemical feed pump if the existing plant pumps have insufficient capacity.

In general, the copper solvent may be applied at any time during plant cold shut-down periods. The iron solvent is normally applied either during plant shut-down or during plant start-up in the temperature range between 140° C. (284° F.) and 200° C. (392° F.). The application temperature may be maintained and controlled by the primary side of the pressurized water reactor. The chemicals may be injected into the steam generators either through an auxiliary feedwater line or a blowdown line.

The high temperature iron removal process can be applied using several chelating agents. Prior to 1991, nitrilotriacetic acid (NTA) was used. Since 1991 EDTA has been used. The process is inhibited by applying it at high temperatures under slightly alkaline and highly reducing conditions. The chemicals injected into the steam generators may be mixed by multiple steam-off operations. Usually, no external heat-up and recirculation systems are required.

The solvent reaction is low at a temperature of 120° C. (248° F.) and below, but it increases rapidly above this temperature due to faster reaction kinetics. The plant-specific application temperature is determined during the qualification program. The process is qualified for chelate concentrations of up to 20% by weight. During the process application more than 90% of the cleaning solvent is normally saturated by iron oxides. An excess of solvent concentration is not needed to remove the deposits. The solvent application concentration depends on the amount of the corrosion products to be removed. Once the iron solvent has reacted with iron oxides it is exhausted and is reported to be essentially benign.

At steam generator operating temperatures, the chemicals used in the iron solvent are either volatile or thermally decompose to volatile products. Any remaining solvent in the steam generator steams off during subsequent power operation.

The copper solvent is an ammonia-based chemical that contains ethylene diamine (EDA) as the selective complexing agent. The solvent performs its dissolution function at low temperatures under aerated and highly alkaline conditions. The process can be controlled since no exothermic reactions are involved. EDA forms stable complexes with Cu¹¹ ions. It does not react well with metallic copper, which needs to be transformed into Cu¹¹ ions.

A low temperature solvent can also be used to remove lead. The lead solvent includes alkaline ammonium-EDTA as a complexing agent. The solvent may be applied under aerated conditions. EDTA forms stable complexes with Pb¹¹ ions. Metallic lead also needs to be oxidized to Pb¹¹ ions for dissolution.

Both the copper and lead solvents can be applied either separately or simultaneously at temperatures below 100° C. (212° F.); typical application temperatures being between 20° C. (68° F.) and 70° C. (158° F.). For both solvents the oxidation of metallic copper or metallic lead in the sludge is accomplished with air. The oxygen consumption for the oxidation is so fast that the process may require permanent air injection. To enhance the penetration of the solvent into the crevices and small volume gaps, a partial vacuum can be applied to the steam generators during the solvent injection. Subsequent air overpressurizing and depressurizing performed in succession enhance solvent mixing and increase the dissolution rate of the copper or lead. The average application time for this process is approximately one day.

While the corrosiveness of the iron solvents is controlled by the process itself, an on-line corrosion monitoring system can be used which uses the technique of monitoring the corrosion hydrogen (H₂). Hydrogen is extremely sensitive to monitoring, even if only a little corrosion takes place. The hydrogen/nitrogen (H₂/N₂) ratio provides additional corrosion information. During process application, the corrosion monitoring system can monitor H₂ either in the steam generator steam samples or in the steam generator water samples. In addition to the hydrogen monitoring, linear polarization resistance (LPR) and electrochemical noise (ECN) can also be used to monitor corrosion during the chemical cleaning process.

Processes which utilize Advanced Scale Conditioning Agents (ASCAs) may be used with second generation or replacement steam generators. These second generation steam generators contain Alloy 600 or Alloy 690 thermal treated tubing and stainless steel, quatrefoil-designed tube support-plates to increase corrosion resistance. Dense tube scale formation in operating steam generators may yield a very low heat transfer margin, which affects short-term thermal performance.

Maintenance ASCA treatment is a chelant-based solution containing amines, a reducing agent and a surfactant. ASCAs are absorbed into the deposit matrix, causing swelling of the chemical bonds and a resultant change in the deposit morphology. The softened deposits are then more easily removed by mechanical cleaning techniques, including sludge lancing, Consolidated Edison Combined Inspection and Lancing (CECIL), Upper Bundle Hydraulic Cleaning (UBHC) and Ultrasonic Energy Cleaning (UEC), all of which may be considered a part of the ASCA processes. Processes which utilize ASCAs are described in U.S. Pat. No. 6,740,168 B2 to Rootham, et al., and U.S. Pat. No. 7,344,602 B2 to Varrin, et al., both of which are incorporated herein by reference. Ultrasonic Energy Cleaning (UEC) is effectively a mechanical method for removing corrosion products, using cavitating bubbles from induced boiling. Ultrasonic transducers may be combined, typically in a radial configuration, to lower the local pressure waves through the water sufficiently to cause nucleate boiling that collapses immediately afterwards. The collapse of the bubble releases solid corrosion products that are then pumped to a filtration system.

After cleaning, the metallic heat transfer surface is conditioned in order to “prime” the surface for application of the nanoparticle dispersion. This procedure includes flushing the polymeric binding agent briefly through the system to coat the heated surfaces. In certain embodiments, the method may include: (a) applying the polymer binding agent to the metallic surface prior to contacting the nanoparticle dispersion with the metallic surface; or (b) applying the polymer binding agent to the metallic surface as a component of the nanoparticle dispersion. The polymeric binding agent which is used to “prime” the surface can therefore be applied in a distinct step prior to nanoparticle deposition, or the polymeric binding agent can be included in the nanoparticle dispersion. The polymeric binding agent may thus be delivered separately in an aqueous or non-aqueous solution or dispersion, or may be delivered within the nanoparticle dispersion.

Suitable polymeric binding agents include, but are not limited to, polyacrylic acid (PAA), polyallylamine hydrochloride (PAH), polystyrene sulfonate (PSS), polyvinyl sulfonate (PVS), or (poly)diallyl-dimethyl-ammonium-chloride (PDAC).

The nanoparticle deposition is performed by bringing the heat transfer apparatus to a temperature and pressure sufficient to boil the nanoparticle dispersion, and passing the nanoparticle dispersion through the apparatus. This step may be prolonged or repeated in order to form numerous layers of suitable thickness on the heated metallic surface.

In certain embodiments, the average surface roughness of the layer(s) of nanoparticles on the treated metallic surface is from about 1 μm to about 20 μm as measured by the confocal microscopy technique. The average thickness of the at least one thin film layer of nanoparticles on the treated metallic surface may range from about 10 nm to about 50 μm, optionally from about 100 nm to about 50 μm.

The present method also provides for the optional curing of the nanoparticle deposition onto the heated metallic surface. After the nanoparticle dispersion is removed from the system, the temperature of the apparatus can be increased above the temperature required to boil the nanoparticle dispersion. Such an increase in the temperature may result, in part, in burning off the polymer binding agent. The increase in temperature also causes the nanoparticle deposition to form a durable bond with the heated metallic surface, so that the nanoparticle deposition cannot easily be scratched or eroded off of the metallic heat transfer surface.

In certain embodiments, the metallic surface comprises a heat transfer fluid-contacting surface of a heat transfer component, or a heat transfer fluid-contacting inner surface of the secondary side of a pressurized water nuclear reactor.

### EXAMPLES

### Flow Boiling

In the following examples, stainless steel test sections were pre-coated with nanoparticles via boiling-induced deposition of a dilute alumina nanoparticle dispersion. These pre-coated test sections, as well as untreated test sections, were then utilized in flow boiling experiments with pure water as the heat exchange fluid. CHF values of the pre-treated and untreated test sections were compared to evaluate the performance of the nanoparticle coated test sections.

### Nanofluid Preparation and Characterization

A concentrated alumina nanoparticle dispersion (20% nanoparticles by weight) was purchased from Nyacol (Ashland, Mass.). This alumina nanofluid was then diluted using deionized water. The mean diameter of the alumina nanoparticle was measured using a dynamic light scattering analyzer and found to be about 40 nm, which confirms what was specified by Nyacol. The alumina nanoparticle dispersion used in pre-coating the test sections is 0.1% by volume (0.1 vol %). The thermophysical properties (viscosity, surface tension and thermal conductivity) of the nanoparticle dispersion have previously been found to be virtually identical to that of water. This is expected for such diluted nanofluids.

### Pre-Treatment of Test Sections

The bare test section was coated using an apparatus known as coating loop. The coating loop is constructed of mostly stainless steel tubing with an outside diameter of 6.35 mm (0.25 inches) and consists of a test section assembly, a pump and an accumulator/heat exchanger system. The test section includes a stainless steel tube having a 6.35 mm (0.25 inches) outside diameter and a thickness of 0.41 mm (0.016 inches), and copper electrodes on both ends of the tube.

The procedure to coat a test section is described as follows. First, approximately 3,000 ml of the nanoparticle dispersion described above was added to the accumulator. The fluid was then circulated through the coating loop using the constant displacement pump. The flow rate was controlled using a needle valve in the bypass loop. Once the flow rate (G=670 kg/m²s) was established, a heat flux of 1 MW/m² was applied to the test section via the copper electrodes using a DC power supply. Bulk fluid temperature was monitored and controlled, by adjusting the chilling water flow rate, so that the inlet temperature remained relatively constant once it reached equilibrium. The coating process was performed for 1.5 hours after equilibrium was established. Three test sections were coated using this procedure.

In certain embodiments, the nanoparticle coating thickness was about 2-3 μm, with the coating thickness reaching a plateau after only a few minutes of boiling. The coating layer was confirmed by energy dispersive spectroscopy (EDS) and scanning electron microscopy (SEM).

### Flow Boiling CHF

The CHF example tests were conducted in a two-phase flow loop. This loop contained a test section, a pre-heater, a heat exchanger, a pump and an accumulator. Most of the loop was constructed with 25.4 mm (1 inch) outside diameter stainless steel tubing. The test section, as described above, included a stainless steel tube having a 6.35 mm (0.25 inches) outside diameter and a thickness of 0.41 mm (0.016 inches) and copper electrodes on both ends of the tube, further including apparatus on both ends to adapt the test section to the necessary tube size in order to be functionally connected to the rest of the flow loop. The heated length was 100 mm (3.94 inches).

Power was supplied to the test section via the copper electrodes located at the ends of the test section, which were connected to two identical DC power supplies operating in parallel. The voltage and the current supplied to the test section were measured using a calibrated voltmeter and an inductive ammeter with uncertainties of less than 2%.

The heat flux on the inner tube surface was calculated as:

$${q}^{″} = \frac{IV}{π {D}_{i} L}$$

where V and I are the voltage and current, respectively, and Dᵢ and L are the inner diameter and the heated length of the test section, respectively. The uncertainty in the measurement of the heat flux was less than ±4%.

K-type thermocouples measured the inlet and outlet temperature of the test section. To measure wall temperature, at least two K-type thermocouples were clamped at the outside surface of the tube at azimuthally different locations directly below the top copper electrodes. The heat loss (defined as the normalized difference between the electric power and the fluid thermal power) was estimated to be less than 10% at low heat flux (q″<1.0 MW/m²) and less than 5% at high heat flux (q″>4.5 MW/m²). All tests were performed at atmospheric pressure. The accumulator, also capable of controlling pressure, was used to purge non-condensable gas at the beginning of each test. A constant-displacement pump controlled the mass flow rate in the loop, which was measured with a flow meter with less than ±5% uncertainty. The mass flux was maintained at 2,500 kg/m²s.

The flow boiling test procedure using an un-treated, bare tubing was as follows. The tube was first cleaned with acetone to remove contaminants. After filling the loop with water, degassing was performed at 60° C. for approximately one hour. Further degassing was done by applying approximately 2.8-3.0 MW/m² heat flux to the tube for 30 minutes. The temperature of the fluid was kept at 60° C. throughout this process. After degassing, the power was turned off and fluid temperature was reduced to the inlet chill water temperature. The mass flux was established and then power was supplied to the tube in constant steps. A six-minute wait allowed steady state to be achieved between each step. Flow rate, test-section current and voltage, inlet and outlet temperature and wall temperature were recorded and monitored at each step simultaneously. The power increase continued until CHF occurred, usually indicated by rupture of the test section.

The procedure to measure CHF using a pre-coated tube was similar to that when a bare tube was used except during the degassing phase. A bare test section was used in the first hour of degassing at 60° C. This bare test section was then replaced with the pre-coated test section. The procedure used for the pre-coated test section was identical to that of untreated tube.

### Results

The CHF values of pure water as measured using bare tubes and pre-coated tubes are listed in the table below. The uncertainty in the measured heat flux is less than ±4%.

TABLE 1
Summary of CHF value of water

| | | | LUT | |
|---|---|---|---|---|
| | CHF | Outlet | Value | CHF |
| Tube | (MW/m²) | Quality | (MW/m²) | ratio |
| Bare 1 | 5.57 | −0.071 | 5.35 | 1.04 |
| Bare 2 | 5.58 | −0.073 | 5.41 | 1.03 |
| Coated 1 | 6.20 | −0.063 | 5.02 | 1.24 |
| Coated 2 | 6.48 | −0.059 | 4.87 | 1.33 |
| Coated 3 | 6.51 | −0.058 | 4.82 | 1.35 |

The CHF values of untreated test sections substantially agreed with the lookup table (LUT) values as shown in D.C. Groeneveld, et al., “The 1995 CHF Look-up Table”, Nuclear Engineering and Design, 163,1-23,1996, which verified that the flow loop performed as expected. The CHF of water with the pre-coated tubes were much higher than that of the LUT values with the given mass flux and outlet quality. The average CHF enhancement of the three examples was 30.5%.

The CHF values of the pre-coated test sections are within 10%, which shows that the nanoparticle coatings of the three test sections were similar. These results show that boiling-induced deposition provides nanoparticle coatings on heated surfaces which enhance CHF. One characteristic of the heater surface modified by the nanoparticle coating was the surface wettability, quantified by contact angle measurement using confocal microscopy. In some embodiments, nanoparticle pre-coated heaters gave water CHF values 35% higher than when a non-coated heater was used.

### Pool Boiling HTC and CHF

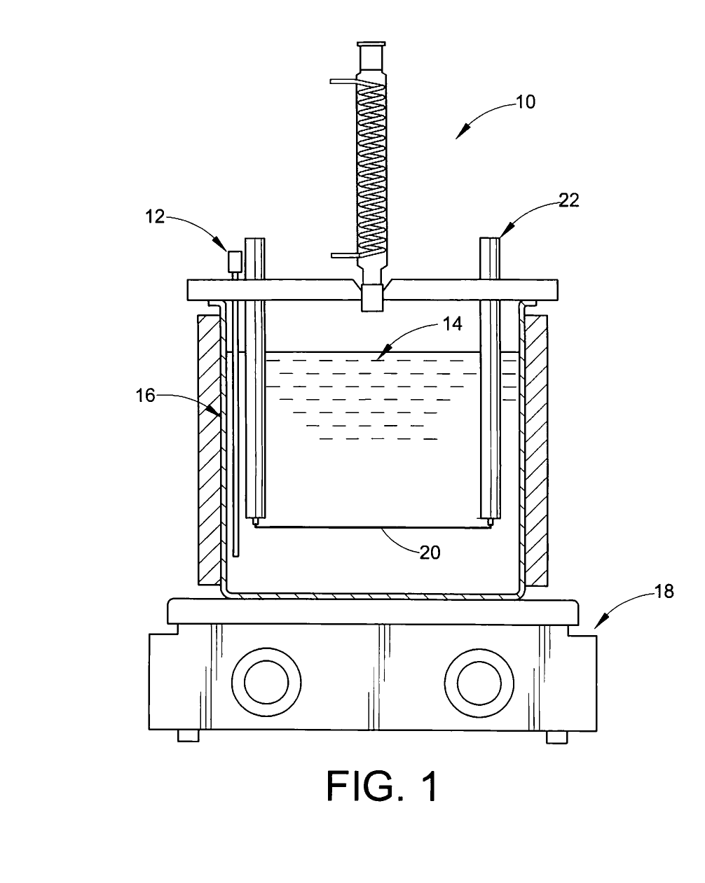

A pool boiling apparatus was used to coat a wire heater with nanoparticles and to determine the boiling heat transfer coefficient (HTC) and CHF of the bare and coated wire, a schematic of which is shown in FIG. 1. To create a nanoparticle coating through boiling induced deposition, a metal wire 20 was placed between two electrodes and exposed to a constant heat flux in a nanoparticle dispersion set out below for approximately 30 minutes.

The boiling HTC and CHF were obtained using the wire pool boiling apparatus 10 and method, using deionized water. To obtain these values, either a bare or pre-coated wire 20 was placed between two copper electrodes 22 and immersed in deionized water 14. The heat flux through the wire 20 was gradually increased by using current increments through the wire 20 of 2, 6, 8, 10, 12 and 13 amps, with increments of 0.5 amps above 13 amps, until the wire 20 reached CHF and broke. A period of three minutes was allowed to pass between each current increase. A 99.98% nickel wire 20 with a diameter of 0.25 mm (0.01 inches) was used as the heater. A K-type thermocouple 12 was used to determine the temperature of the fluid in the vessel 16, a borosilicate beaker. The deionized water 14 was maintained at saturation temperature and atmospheric pressure with a hot plate 18. The data acquisition system (not shown) was the Multifunction Switch/Measure Unit, model 34980A manufactured by Agilent Technologies (Santa Clara, Calif.).

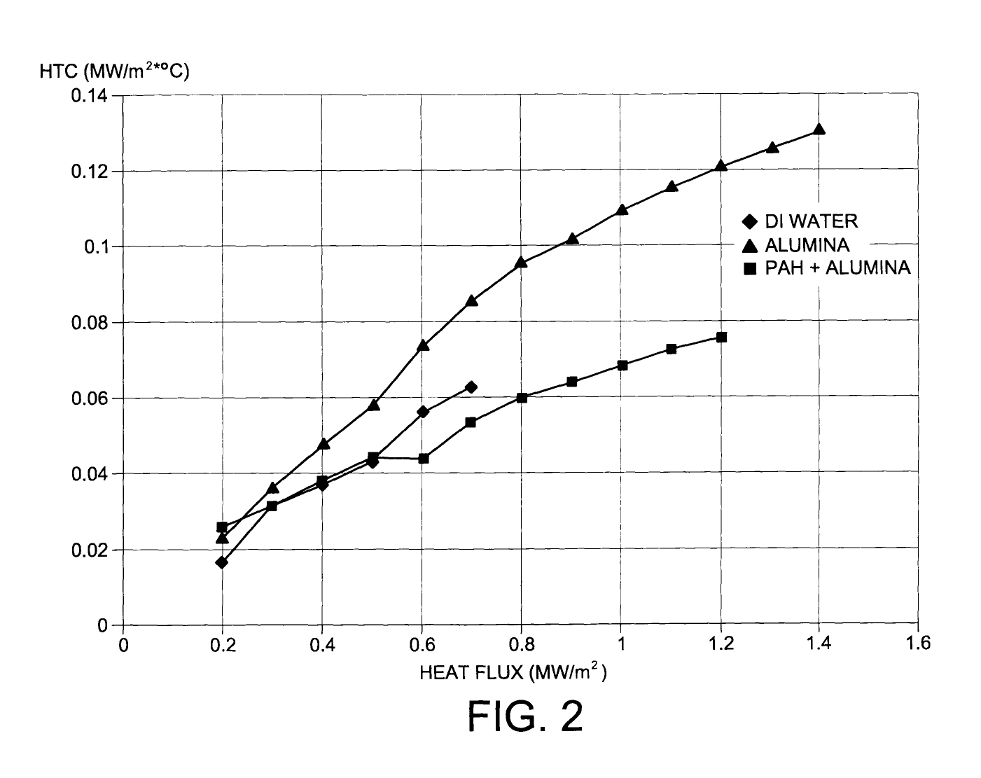

Tests were conducted using bare metal wire, wire pre-coated with an alumina nanoparticle dispersion, and wire pre-coated with an alumina nanoparticle and poly(allylamine hydrochloride) (PAH) dispersion mixture. The alumina nanoparticle dispersion used for pre-coating the metal wire was about 1 vol % in concentration. The alumina and PAH dispersion mixture concentrations were about 0.1 vol % and 125 ppm respectively. As shown in FIG. 2, alumina nanoparticles deposited on the wire affect an increase in the HTC and CHF as compared to a bare wire. Further, adding a small amount of PAH, as described above, increased the HTC at low heat fluxes, and also increased the CHF, as compared to both the alumina coated wire and the bare wire. Alumina/PAH coatings typically showed better adhesion compared to alumina coating alone.

In certain embodiments, when compared to coating derive from pure alumina nanofluids, specifically 0.1% dispersions of alumina as described above, the coating obtained from a combined alumina/PAH nanofluid as described above had the following effects. CHF was enhanced by approximately 40%, compared to an enhancement of approximately 37% with alumina alone over uncoated wire. HTC remained substantially the same with alumina/PAH coating, compared to a degradation of approximately 27% with alumina alone. Thus, the combined alumina/PAH nanoparticle dispersion derived coating enhanced CHF similarly to the dispersion of alumina alone, but the alumina/PAH dispersion did not result in an appreciable degradation of HTC.

### Adhesion

Adhesion is the attractive force that holds two bodies together at their interface. In adhesion testing, a known force is applied to the interface and the stress at which separation occurs is recorded. This stress is then used as a quantitative measure of the adhesive force. The force may vary if the applied force is shear, normal, torsional, or some combination of these relative to the interface. The coating on a substrate will crack only if the attractive force is strong enough to transfer applied strain to the coating. If a coating fails by cracking without spallation because the tensile stress exceeds the ultimate tensile strength (UTS), then the adhesion strength is very high.

There are four methods which are typically used for determining coating adhesion: tape tests, scratch tests, bend/tensile tests, and laser shock adhesion tests. Variations of these methods are included in the ASTM published standards for coating adhesion. Tape, scratch and laser shock adhesion tests determine the amount of stress required to remove a coating from the material, while bend/tensile tests measure the difference between the elastic modulus of the coating material and the elastic modulus of the bare material.

### Tape Tests

Wires were coated with either alumina dispersions or alumina/PAH dispersions, as discussed above. Transparent tape, such as that available from 3M under the trademark Scotch, was applied to the coated wire and removed, and the amount of coating removed indicated the durability of the coating on the wire. When applied to the wire pre-coated with an alumina only dispersion, the tape stripped the coating from the wire in non-uniform patches, exposing significant amounts of the bare wire.

When the tape was applied to the wire pre-coated with the alumina/PAH coating, the coating was removed in a stippled pattern and did not expose patches of bare wire. The alumina/PAH coating remaining on the wire was relatively uniform.

### Bend Tests

Wires were coated with either alumina dispersions or alumina/PAH dispersions, as discussed above. The wires were then bent in order to determine the elastic properties of the coating with respect to the elastic properties of the wire. The alumina only coating experienced significant cracking and limited spallation. The alumina/PAH coating did not experience any cracking or spallation when applied to the same type of metal wire as was the alumina only coating. In general, the alumina/PAH coating was not as thick as the alumina only coating.

The adhesion test results presented illustrate the relative resilience of the alumina/PAH coating. Qualitatively, the composite alumina/PAH coating was more resilient to the tape tests than the alumina coating. Further, the alumina/PAH coating did not experience significant cracking at tensile stresses that induced cracking and spallation in the alumina coating.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A method for in-situ treatment of a metallic surface utilizing a nanoparticle dispersion in order to increase at least one of (i) the critical heat flux, (ii) the boiling heat transfer rate, or (iii) the corrosion resistance of the metallic surface when in operation without a nanofluid heat transfer liquid, comprising:
(1) cleaning the metallic surface;
(2) conditioning the metallic surface to enhance nanoparticle binding to the metallic surface by applying a polymeric binding agent;
(3) forming at least one thin film layer of nanoparticles on the metallic surface by contacting the nanoparticle dispersion with the metallic surface at a temperature and pressure sufficient to boil the nanoparticle dispersion; and,
(4) optionally curing the nanoparticle layer by heating the metallic surface to a temperature higher than the temperature sufficient to boil the nanoparticle dispersion.

2. The method of claim 1, wherein the metallic surface comprises a heat transfer fluid-contacting surface of a heat transfer component.

3. The method of claim 1, wherein the nanoparticle dispersion comprises a dispersion in at least one of a liquid solvent or dispersive agent, of at least one of (i) metal nanoparticles; (ii) metal-oxide nanoparticles; (iii) carbon nanoparticles; (iv) nanoparticles of at least one of types (i), (ii), or (iii) stabilized by surfactants; or (v) nanoparticles of at least one of types (i), (ii), (iii) or (iv) with the polymeric binding agent.

4. The method of claim 3, wherein the nanoparticle dispersion comprises from about 0.01% to about 5% by volume of nanoparticles.

5. The method of claim 3, wherein the carbon nanoparticles comprise at least one of carbon nanotubes, diamond, graphite or fullerenes.

6. The method of claim 3, wherein the liquid solvent is water.

7. The method of claim 3, wherein the liquid solvent is an organic solvent.

8. The method of claim 3, wherein the liquid solvent is an inorganic solvent.

9. The method of claim 1, wherein cleaning the metallic surfaces comprises at least one of chemically flushing, sludge lancing, mechanically cleaning, or ultrasonically cleaning the metallic surface.

10. The method of claim 9, further comprising utilizing a stream of liquid to remove any residuals after the at least one of chemical flushing, sludge lancing, mechanically cleaning, or ultrasonically cleaning the metallic surface.

11. The method of claim 1 wherein the nanoparticles comprise at least one of alumina, titania, silica, zinc oxide, iron oxide, ceria, zirconia, gold, silver, or copper.

12. The method of claim 1, wherein the polymeric binding agent comprises at least one of polyacrylic acid, polyallylamine hydrochloride, polystyrene sulfonate, polyvinyl sulfonate, or (poly)diallyl-dimethyl-ammonium-chloride.

13. The method of claim 1, wherein the average particle size of the nanoparticles is from about 1 nm to about 1,000 nm.

14. The method of claim 1, wherein the average surface roughness of the at least one thin film layer of nanoparticles on the treated metallic surface is from about 1 μm to about 20 μm.

15. The method of claim 1, wherein the average thickness of the at least one thin film layer of nanoparticles on the treated metallic surface is from about 10 nm to about 50 μm, optionally from about 100 nm to about 50 μm.

16. The method of claim 1, including applying the polymer binding agent to the metallic surface prior to contacting the nanoparticle dispersion with the metallic surface.

17. The method of claim 1, including applying the polymer binding agent to the metallic surface as a component of the nanoparticle dispersion.

18. The method of claim 1, wherein the metallic surface comprises a heat transfer fluid contacting inner surface of a pressurized water nuclear reactor secondary side component.

19. A method of increasing the flow boiling critical heat flux of a heat transfer apparatus by treating the metallic surfaces of the heat transfer apparatus according to the method of claim 1.

20. A heat transfer apparatus comprising a metallic surface treated according to the method of claim 1.
